(19) United States
(12) Patent Application Publication
(10) Pub. No.: US 2024/0408764 A1
(43) Pub. Date: Dec. 12, 2024

(54) CONTROL DEVICE FOR CONTROLLING ROBOT INCLUDING PLURALITY OF COMPONENT MEMBERS, ROBOT DEVICE PROVIDED WITH CONTROL DEVICE, AND OPERATING DEVICE FOR SETTING PARAMETERS

(71) Applicant: Fanuc Corporation, Yamanashi (JP)

(72) Inventor: Yasuhiro Naitou, Minamitsuru-gun, Yamanashi (JP)

(73) Assignee: Fanuc Corporation, Yamanashi (JP)

(21) Appl. No.: 18/699,370

(22) PCT Filed: Oct. 14, 2021
(86) PCT No.: PCT/JP2021/038126

§ 371 Date: Apr. 8, 2024

(51) Int. Cl. B25J 9/16

(52) U.S. Cl. CPC B25J 9/1694

(57) ABSTRACT

This control device for a robot controls a robot that includes a plurality of component members. The control device comprises sensors for detecting action states of the component members, and a processing unit that controls actions of the robot on the basis of the outputs of the sensors. The processing unit includes a specific member setting unit that sets one or more component members among the plurality of component members as a specific member. The processing unit includes a determining unit that determines an action state of the specific member on the basis of the outputs of the sensors, and an action changing unit that changes the action of the robot on the basis of the determination result of the determining unit.

### CROSS REFERENCE TO RELATED APPLICATIONS

This is the U.S. National Phase application of PCT/JP2021/038126, filed Oct. 14, 2021, the disclosures of this application being incorporated herein by reference in their entireties for all purposes.

### FIELD OF THE INVENTION

The present invention relates to a controller for controlling a robot including a plurality of constituent members, a robot device provided with a controller, and an operating device for setting a parameter.

### BACKGROUND OF THE INVENTION

In the related art, a robot device in which an operator performs work in cooperation with a robot is known. For example, there is known a robot device in which the robot device and an operator cooperate in conveying a workpiece. In a robot device that performs work in cooperation with an operator, the robot and the operator can perform work without providing a safety fence at an operation region around the robot (e.g., Japanese Unexamined Patent Publication No. 2019-25604A).

During a period in which a robot is operating, the robot may come into contact with an object or an operator. For example, when an operator performs work in cooperation with a robot, the robot may come into contact with a peripheral device or the operator. A contact force applied to the operator by the robot corresponds to an external force acting on the robot. In order for the operator to perform work safely, an upper limit value of such a contact force is defined by a standard or the like. A known robot device performs control for stopping a robot by detecting an external force acting on the robot and avoiding an object or an operator in contact with the robot by performing an retreating operation (e.g., Japanese Unexamined Patent Publication No. 2020-192652A).

### PATENT LITERATURE

PTL 1: Japanese Unexamined Patent Publication No. 2019-25604A
PTL 2: Japanese Unexamined Patent Publication No. 2020-192652A

### SUMMARY OF THE INVENTION

When a robot device performs work in cooperation with an operator, a controller can calculate an external force applied to the robot device and control the robot based on the magnitude of the external force. The portions at which the operator comes into contact with the robot device vary depending on the content of the work performed by the robot device or the positional relationship between the robot device and the operator. In this regard, since the controller calculates the external force inclusive of a margin in consideration of the safety of the operator, the external force may be calculated being large. As a result, there has been a problem in that the operation of the robot device is restricted and work efficiency is reduced.

A first aspect of the present disclosure is a controller for controlling a robot including a plurality of constituent members. The controller includes a sensor that detects a state of operation of a constituent member, and a processing unit that controls operation of the robot based on an output of the sensor. The processing unit includes a specific member setting unit that sets at least one constituent member out of the plurality of constituent members as a specific member, a determination unit that determines a state of operation of the specific member based on an output of the sensor, and an operation change unit that changes the operation of the robot based on a determination result of the determination unit.

A second aspect of the present disclosure is a robot device including the controller described above and a robot, the robot including a plurality of constituent members.

A third aspect of the present disclosure is an operating device for setting a parameter for controlling a robot. The operating device includes a display part that displays an image of the robot. The operating device includes an acquisition unit that acquires information for setting, from among constituent members of the robot, a specific member having a possibility of contact based on operation on the image displayed on the display part, and an output unit that outputs the information for setting the specific member.

According to an aspect of the present disclosure, it is possible to provide a controller that controls operation of a robot based on a state of operation of a specific member selected from a plurality of constituent members of the robot, a robot device including the controller, and an operating device that sets a parameter.

### BRIEF DESCRIPTION OF DRAWINGS

FIG. 1 is a schematic diagram of a first robot device according to an embodiment.

FIG. 2 is a block diagram of the first robot device.

FIG. 3 is a schematic diagram for explaining control in a comparative example of the first robot device.

FIG. 4 is a first image displayed on a display part according to the embodiment.

FIG. 5 is a schematic diagram of a capsule model used for control according to the embodiment.

FIG. 6 is a schematic diagram of a first robot with a capsule model arranged.

FIG. 7 is a schematic diagram illustrating a first state of the first robot device.

FIG. 8 is a schematic diagram illustrating a second state of the first robot device.

FIG. 9 is a schematic diagram illustrating a third state of the first robot device.

FIG. 10 is a second image displayed on the display part.

FIG. 11 is a third image displayed on the display part.

FIG. 12 is a schematic diagram for explaining a state in which the first robot device enters an operator work area.

FIG. 13 is a block diagram of a second robot device according to the embodiment.

FIG. 14 is a schematic diagram of the second robot device.

FIG. 15 is a schematic diagram of a third robot device according to the embodiment.

FIG. 16 is a block diagram of the third robot device.

### DETAILED DESCRIPTION OF EMBODIMENTS OF THE INVENTION

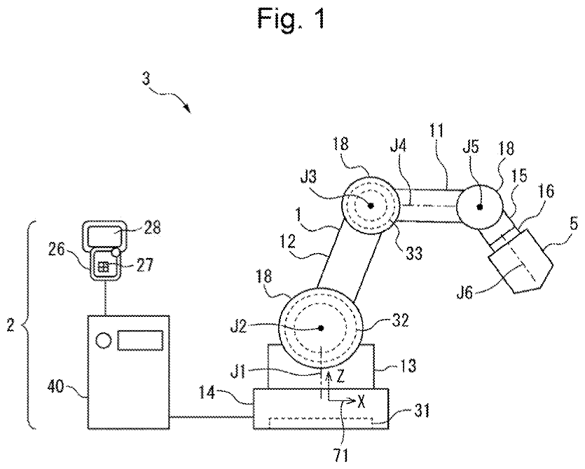

A controller for a robot, a robot device including the controller, and an operating device for setting a parameter according to an embodiment will be described with reference to FIG. 1 to FIG. 16. The robot device according to the present embodiment includes a robot including a plurality of constituent members, a work tool attached to the robot, and a controller for controlling the robot and the work tool. The robot device according to the present embodiment includes a cooperative robot that performs work in cooperation with an operator.

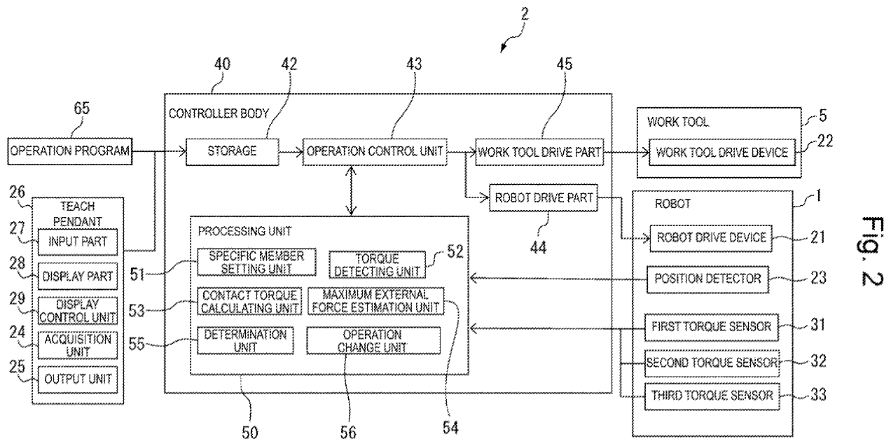

FIG. 1 is a schematic diagram of a first robot device according to the present embodiment. FIG. 2 is a block diagram of the first robot device according to the present embodiment. Referring to FIG. 1 and FIG. 2, a first robot device 3 includes a work tool 5 that performs a predetermined work and a robot 1 that moves the work tool 5. The first robot device 3 includes a controller 2 that controls the first robot device 3. Any device suitable for work performed by the robot device 3 can be employed as the work tool 5. For example, a hand or the like for gripping and releasing a workpiece can be employed as the work tool.

The robot 1 of the present embodiment is an articulated robot including a plurality of joints 18. The robot 1 includes a plurality of constituent members. The plurality of constituent members is mutually coupled via joints. The robot 1 includes a base 14 fixed to an installation surface and a turning base 13 supported by the base 14. The turning base 13 rotates about a drive axis J1 with respect to the base 14. The robot 1 includes an upper arm 11 and a lower arm 12. The lower arm 12 is supported by the turning base 13. The lower arm 12 rotates about a drive axis J2 with respect to the turning base 13. The upper arm 11 is supported by the lower arm 12. The upper arm 11 rotates about a drive axis J3 with respect to the lower arm 12. Further, the upper arm 11 rotates about a drive axis J4 which is parallel to an extending direction of the upper arm 11.

The robot 1 includes a wrist 15 supported by the upper arm 11. The wrist 15 rotates about a drive axis J5. Further, the wrist 15 includes a flange 16 that rotates about a drive axis J6. The work tool 5 is fixed on the flange 16. In the present embodiment, the base 14, the turning base 13, the lower arm 12, the upper arm 11, the wrist 15, and the work tool 5 correspond to the constituent members of the robot device 3. The robot 1 is not limited to this configuration, and any robot that can change the position and orientation of the work tool can be employed.

The robot 1 of the present embodiment includes a robot drive device 21 including drive motors for driving the constituent members such as the upper arm 11. The work tool 5 includes a work tool drive device 22 including a drive motor, a cylinder, or the like for driving the work tool 5.

The controller 2 includes a controller body 40 and a teach pendant 26 through which an operator operates the controller body 40. In the present embodiment, the teach pendant 26 functions as the operating device for setting a parameter for controlling the robot. The controller body 40 includes an arithmetic processing device (a computer) that includes a central processing unit (CPU) as a processor. The arithmetic processing device includes a random access memory (RAM), a read only memory (ROM), and the like which are connected to the CPU via a bus. The robot 1 is driven based on operation commands from the controller 2. The robot device 3 automatically performs work based on an operation program 65.

The controller body 40 includes a storage 42 that stores any information regarding the robot device 3. The storage 42 can be configured with a non-transitory storage medium capable of storing information. For example, the storage 42 can be configured with a storage medium such as a volatile memory, a nonvolatile memory, a magnetic storage medium, or an optical storage medium. The operation program 65 prepared in advance for performing the operation of the robot 1 is stored in the storage 42.

An operation control unit 43 sends an operation command for driving the robot 1 based on the operation program 65 to a robot drive part 44. The robot drive part 44 includes an electric circuit that drives a drive motor and supplies electricity to the robot drive device 21 based on the operation command. The operation control unit 43 also sends, to a work tool drive part 45, an operation command for driving the work tool drive device 22. The work tool drive part 45 includes an electrical circuit that drives a motor or the like and supplies electricity to the motor or the like based on the operation command.

The operation control unit 43 corresponds to a processor that is driven in accordance with the operation program 65. The processor is configured to be able to read information stored in the storage 42. The processor functions as the operation control unit 43 by reading the operation program 65 and performing control defined in the operation program 65.

The robot 1 includes a state detector for detecting the position and orientation of the robot 1. The state detector according to the present embodiment includes a position detector 23 attached to the drive motor of each drive axis of the robot drive device 21. The position detector 23 can be formed of, for example, an encoder that detects the rotational position of the output shaft of the drive motor. The position and orientation of the robot 1 are detected from the output of each position detector 23.

A reference coordinate system 71 that does not move when the position and orientation of the robot 1 are changed is set for the robot device 3. In the example illustrated in FIG. 1, the origin of the reference coordinate system 71 is arranged at the base 14 of the robot 1. The reference coordinate system 71 is also called a world coordinate system. In the reference coordinate system 71, the position of the origin is fixed and the directions of the coordinate axes are also fixed. The reference coordinate system 71 has, as coordinate axes, an X-axis, a Y-axis, and a Z-axis that are orthogonal to each other. In addition, a W-axis is set as a coordinate axis around the X-axis. A P-axis is set as a coordinate axis around the Y-axis. An R-axis is set as a coordinate axis around the Z-axis.

A tool coordinate system having an origin set at a position of choice on the work tool is set for the robot device 3. The tool coordinate system changes in position and orientation together with the work tool. In the present embodiment, the origin of the tool coordinate system is set at a tool center point. The position of the robot 1 corresponds to the position of the tool center point in the reference coordinate system 71. Also, the orientation of the robot 1 corresponds to the orientation of the tool coordinate system with respect to the reference coordinate system 71.

The teach pendant 26 is connected to the controller body 40 via a communication device. The teach pendant 26 includes an input part 27 for inputting information regarding the robot device 3. The input part 27 is formed of input members such as a keyboard and dials. The teach pendant 26 includes a display part 28 that displays the information regarding the robot device 3. The display part 28 can be formed of a display panel capable of displaying information, such as a liquid crystal display panel or an organic electro luminescence (EL) display panel. When the teach pendant includes a display panel of touch panel type, the display panel functions as an input part and a display part.

The teach pendant 26 includes an arithmetic processing device (a computer) including a CPU as a processor. The teach pendant 26 includes a display control unit 29 that transmits a command for an image to be displayed on the display part 28. The display control unit 29 controls an image displayed on the display part 28. The display control unit 29 controls an image displayed on the display part 28 in response to operation on the input part 27 by an operator. The display part 28 displays information regarding the constituent members of the robot 1. The display part 28 of the present embodiment is configured to display an image of the robot 1.

The teach pendant 26 includes an acquisition unit 24 that acquires information for setting, from among the constituent members of the robot 1, a specific member having a possibility of contact with a person. The acquisition unit 24 acquires the information for setting a specific member based on operation by an operator on an image displayed on the display part 28. The teach pendant 26 includes an output unit 25 that outputs the information for setting a specific member. The output unit 25 outputs the information for setting a specific member to a specific member setting unit 51. Each unit of the display control unit 29, the acquisition unit 24, and the output unit 25 corresponds to a processor that is driven in accordance with a predetermined program. The processor functions as each unit by executing control defined in the program. The teach pendant 26 includes a storage configured with a non-transitory storage medium capable of storing information.

The robot 1 of the first robot device 3 includes torque sensors 31, 32, and 33 arranged at the joints 18. The torque sensors 31, 32, and 33 detect torques around the drive axes J1, J2, and J3 about which the constituent members of the robot 1 rotate, respectively. In the example illustrated in FIG. 1, the first torque sensor 31 detects a torque around the drive axis J1. The second torque sensor 32 detects a torque around the drive axis J2. The third torque sensor 33 detects a torque around the drive axis J3. Outputs of the torque sensors 31, 32, and 33 and an output of the position detector 23 are transmitted to a processing unit 50 of the controller body 40.

Each of the torque sensors 31, 32, and 33 functions as a sensor for detecting a state of operation of a constituent member. The torque sensor can detect a torque depending on states of operation of the constituent members located on a distal end side of the robot with respect to a joint at which the torque sensor is arranged. For example, the first torque sensor 31 functions as a sensor for detecting states of operation of the lower arm 12, the upper arm 11, the wrist 15, and the work tool 5.

The controller body 40 includes the processing unit 50 that controls the operation of the robot 1 based on outputs of the torque sensors 31, 32, and 33. The processing unit 50 includes the specific member setting unit 51 that sets at least one constituent member out of the plurality of constituent members of the robot as a specific member. In the present embodiment, a constituent member selected from the plurality of constituent members of the robot in determining the operation of the robot is referred to as a specific member. In the present embodiment, a constituent member with which an operator is likely to come into contact can be selected as a specific member.

The processing unit 50 includes a torque detecting unit 52 that detects torques around the respective drive axes based on outputs of the torque sensors 31, 32, and 33. The processing unit 50 includes a contact torque calculating unit 53 that calculates a contact torque when an operator comes into contact with the robot. The contact torque corresponds to a torque caused by an external force acting on the robot 1. The contact torque calculating unit 53 calculates a contact torque by subtracting a torque related to an internal force of the robot from a torque detected by the torque detecting unit 52. The torque related to an internal force of the robot can be calculated from an operation state of the robot 1. For example, the torque related to an internal force is calculated based on the position and orientation of the robot 1, and speeds and accelerations when the constituent members are driven around the respective drive axes.

The processing unit 50 includes a maximum external force estimation unit 54 that estimates a maximum value of an external force acting on the robot when a person comes into contact with the robot. The processing unit 50 includes a determination unit 55 that determines a state of operation of a specific member. The processing unit 50 includes an operation change unit 56 that changes the operation of the robot 1 based on a determination result of the determination unit 55. Each unit of the above described processing unit 50 and the specific member setting unit 51, the torque detecting unit 52, the contact torque calculating unit 53, the maximum external force estimation unit 54, the determination unit 55, and the operation change unit 56 included in the processing unit 50 corresponds to a processor that is driven in accordance with the operation program 65. The processor functions as each unit by executing control defined in the operation program 65.

In the present embodiment, the units included in the processing unit 50 such as the specific member setting unit 51 are arranged at the controller body 40, but the configuration is not limited thereto. The units included in the processing unit 50 may be arranged at the teach pendant 26. In other words, the processor of the teach pendant may function as the units included in the processing unit 50. For example, the teach pendant 26 may include the specific member setting unit. In addition, the units included in the teach pendant 26 such as the display control unit 29 may be arranged at the controller body 40. For example, the processing unit may include the display control unit, the acquisition unit, and the output unit. Alternatively, at least one of the units included in the processing unit 50 and the teach pendant 26 may be arranged at an arithmetic processing device different from the controller body and the teach pendant.

The robot device 3 according to the present embodiment performs work in the vicinity of a work area in which an operator is present. The operator may come into contact with the robot 1. When a force (contact force) received by the operator from the robot is small, there is no problem, and the robot device and the operator can continue the work. On the other hand, when a force received by the operator from the robot is large, the controller restricts the operation of the robot. A contact force that can be applied to a person by a robot is defined, for example, in the international standard ISO/TS15066. A contact force received by the operator from the robot corresponds to an external force received by the robot from the operator.

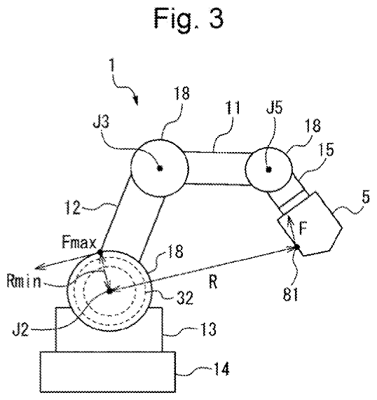

FIG. 3 is a schematic diagram of the robot and the work tool of the first robot device. First, a reference example of control of the robot device will be described. The controller controls the operation of the robot based on an external force received by the robot from an operator. In this case, control based on the output of the second torque sensor 32 arranged at the joint 18 at which the lower arm 12 rotates will be described. The torque sensor 32 detects a torque around the drive axis J2. When the lower arm 12 rotates about the drive axis J2, the positions and orientations of the lower arm 12 as well as the upper arm 11, the wrist 15, and the work tool 5 which are coupled on the distal end side of the lower arm 12 are changed.

The operator may come into contact with these constituent members. In FIG. 3, when the operator comes into contact with a contact point 81 of the work tool 5, an external force F is applied to the work tool 5. A distance between the contact point 81 and the drive axis J2 is a rotation radius R. The torque detecting unit 52 detects, from the torque sensor 32, a torque obtained by adding an external force and an internal force of the robot. The contact torque calculating unit 53 calculates a contact torque by subtracting a torque related to the internal force from the torque detected by the torque sensor 32. The contact torque calculating unit 53 calculates the contact torque (Fx R).

In the example illustrated in FIG. 3, the operator may come into contact with all the constituent members arranged on the distal end side of the robot 1 with respect to the drive axis J2. Thus, in estimating an external force acting on the robot 1 from the contact torque, a small rotation radius is adopted so that the external force is calculated to be large in consideration of safety. In the example illustrated in FIG. 3, among surfaces of the constituent members that are movable, the surface of the constituent member closest to the drive axis J2 is a surface of the lower arm 12. Thus, a minimum radius Rmin of a point arranged closest to the drive axis J2 on the surface of the lower arm 12 can be adopted.

The maximum external force estimation unit 54 calculates a maximum external force Fmax using the minimum radius Rmin. The maximum external force Fmax is a value obtained by dividing the contact torque by the minimum radius (Fx R/Rmin). Next, when the maximum external force exceeds a determination value, the controller can restrict the operation of the robot. In this way, by using a minimum radius as a rotation radius in calculating an external force from a contact torque, it is possible to calculate a maximum external force at the time of contact with a moving constituent member, and to safely perform an evaluation.

On the other hand, in many cases, a minimum radius Rmin is smaller than an actual rotation radius R. In this case, a calculated maximum external force Fmax is larger than an actually applied external force F. In particular, when a difference between a minimum radius Rmin and an actual rotation radius R is large, a maximum external force Fmax is calculated being extremely large. As a result, the operation range of the robot is reduced, the speed of the robot is reduced, and the work efficiency is reduced.

On the other hand, in the control according to the present embodiment, at least one constituent member out of the plurality of constituent members is set as a specific member. The controller 2 calculates a maximum external force based on a state of operation of the specific member so as to control the robot 1. In other words, the controller 2 can perform determination without using the operation of the constituent members other than the specific member. In this case, control based on the output of the second torque sensor 32 arranged at the joint 18 at which the lower arm 12 rotates will be described.

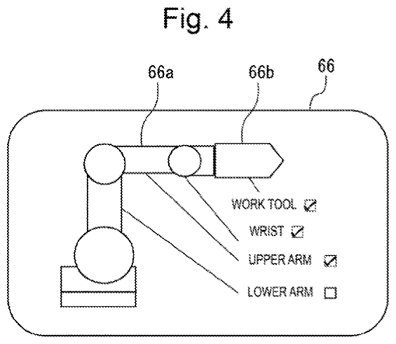

FIG. 4 illustrates a first image displayed on the display part of the teach pendant according to the present embodiment. In a first control of the first robot device 3, first, an operator selects a specific member from the plurality of constituent members of the robot device 3.

Referring to FIG. 2 and FIG. 4, in the first control, the specific member setting unit 51 sets a specific member based on operation by the operator on an image displayed on the display part 28. In a first image 66, the display part 28 displays an image of the robot device including an image 66a of the robot and an image 66b of the work tool. The image 66a of the robot is created in advance and stored in the storage 42. The image 66b of the work tool can be created by the operator operating the input part 27. The image of the work tool can be changed depending on the work tool used. In this example, a two-dimensional image of the robot device is displayed, but the configuration is not limited thereto. A three-dimensional image of the robot device may be displayed.

The display part 28 displays a list of the constituent members of the robot 1. The operator can operate an image displayed on the display part 28 by operating the input part 27. The operator selects at least one specific member from the list of the constituent members of the robot 1. The operator can select constituent members with which the operator is likely to come into contact. In this case, the operator has selected the work tool, the wrist, and the upper arm. The acquisition unit 24 acquires the constituent members of the robot 1 selected by the operation on the image displayed on the display part 28 as information for setting a specific member. The output unit 25 outputs the constituent members selected by the operator to the specific member setting unit 51. The specific member setting unit 51 sets the wrist, the upper arm, and the work tool, which are the constituent members selected on the display part 28, as specific members.

In an actual work, during a period in which the robot device is driven based on the operation program, the contact torque calculating unit 53 of the processing unit 50 calculates a contact torque based on a torque detected by the torque detecting unit 52. Next, the maximum external force estimation unit 54 estimates a maximum external force. The maximum external force is the largest external force that is expected when the operator comes in contact with any of the constituent members. In the present embodiment, a maximum external force when the operator comes into contact with the specific member is estimated. In calculation for estimating a maximum external force according to the present embodiment, a capsule model formed so as to correspond to each constituent member is used.

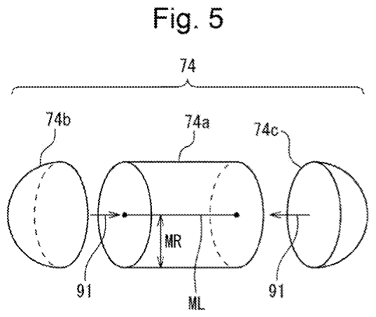

FIG. 5 illustrates a schematic diagram of a capsule model in the present embodiment. As indicated by an arrow 91, a capsule model 74 has a shape in which hemispherical portions 74b and 74c are joined to both sides of a cylindrical portion 74a. The capsule model 74 includes a surface formed using a certain distance MR from a line segment ML. The capsule model 74 can be represented by symbols (ML, MR). The distance MR is a radius from an arbitrary point on the line segment ML.

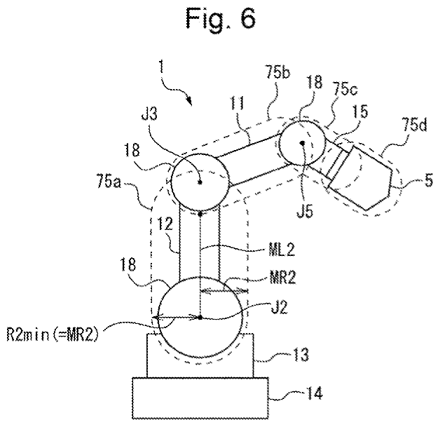

FIG. 6 illustrates a schematic diagram when a capsule model is applied to the robot of the present embodiment. A capsule model can be created for a constituent member that is movable. In this example, a capsule model 75a is set for the lower arm 12. A capsule model 75b is set for the upper arm 11. A capsule model 75c is set for the wrist 15. A capsule model 75d is set for the work tool 5. Each of the capsule models 75a to 75d has a size in which each of the constituent members is arranged.

A line segment ML and a distance MR are set for the constituent member. The capsule model 75a that operates at the drive axis J2 is represented by symbols (ML2, MR2). Similarly, the capsule model 75b is represented by symbols (ML3, MR3), and the capsule model 75c is represented by symbols (ML5, MR5). The capsule model 75d of the work tool is represented by symbols (MLT, MRT). The outer circumferential surface of the capsule model is generated when the position and orientation of the line segment ML are determined. The position and orientation of the line segment ML can be set in a coordinate system defined for each drive axis. Coordinate values in the reference coordinate system 71 are calculated from coordinate values in coordinate systems of the drive axis.

The capsule model for each constituent member can be created in advance by the operator. Each capsule model can be made in any size and arranged at any position so as to enclose the constituent member. Alternatively, two or more capsule models may be set for one constituent member. According to this configuration, capsule models can be set so as to correspond to complicated shapes of constituent members, and precise control can be performed.

Next, a method by which the maximum external force estimation unit 54 calculates a minimum radius for calculating a maximum external force from a contact torque will be described. A surface of a capsule model corresponds to a surface of a constituent member. When the specific member setting unit 51 sets a specific member, the lower arm 12 may be included. In that case, the surface of the constituent member closest to the drive axis J2 is a surface of the lower arm 12. The minimum radius R2min from the drive axis J2 is equal to a distance MR2 from a point on the line segment ML2 to a surface of the capsule model 75a. Next, a method of calculating a minimum radius from a drive axis to a distant constituent member will be described.

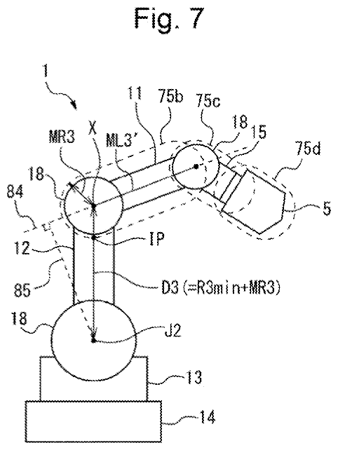

FIG. 7 is a schematic diagram of a first state when the first robot device of the present embodiment is driven. FIG. 7 is an explanatory diagram in calculating a minimum radius R3min of the upper arm 11. At the upper arm 11, the capsule model 75b represented by symbols (ML3, MR3) is arranged. The minimum distance from the drive axis J2 to a surface of the capsule model 75b corresponds to a minimum radius R3min.

The line segment ML3 of the capsule model 75b is represented in the reference coordinate system 71 based on the position and orientation of the robot 1. The end points of the line segment ML3 are represented by coordinate values in the reference coordinate system 71. First, a rotation plane perpendicular to the drive axis J2 is set. Any position on the drive axis J2 can be selected as a position of the rotation plane. In this case, the same plane as the paper surface is set as the rotation plane perpendicular to the drive axis J2.

Next, a line segment ML3′ obtained by projecting the line segment ML3 of the capsule model 75b onto the rotation plane is calculated. Then, a straight line 84 including the line segment ML3′ is calculated. A perpendicular line 85 perpendicularly intersecting the straight line 84 from the drive axis J2 on the rotation plane is calculated. At this time, the intersection point between the straight line 84 and the perpendicular line 85 is arranged outside the line segment ML3′. In this case, one end point of the line segment ML3′ is a point X on the line segment ML3′ at which the distance from the drive axis J2 to the line segment ML3′ is the smallest. Next, a distance D3 between the drive axis J2 and the point X on the rotation plane is calculated. An approaching point IP is a point closest to the drive axis J2 on a surface of the capsule model 75b. The distance between the approaching point IP and the drive axis J2 is a minimum radius R3min. Thus, the minimum radius R3min can be calculated by subtracting a distance MR3 of the capsule model 75b from the distance D3.

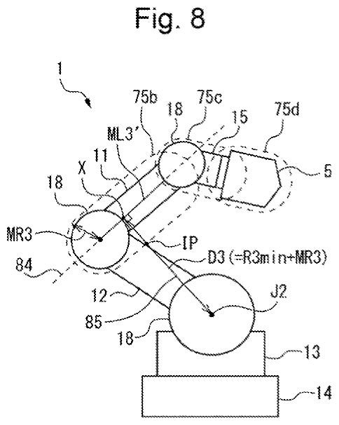

FIG. 8 is a schematic diagram illustrating a second state when the first robot device of the present embodiment is driven. Also at the position and orientation of the robot 1 illustrated in FIG. 8, a straight line 84 including a line segment ML3′ obtained by projecting a line segment ML3 of the capsule model 75b onto a rotation plane is generated. A perpendicular line 85 perpendicularly intersecting the straight line 84 on the rotation plane is generated. At this time, the perpendicular line 85 intersects the line segment ML3′. In this case, the intersection point intersecting the perpendicular line 85 is a point X at which the distance from the drive axis J2 to the line segment ML3′ is the smallest. Then, a distance D3 between the point X and the drive axis J2 is calculated. A minimum radius R3min can be calculated by subtracting a distance MR3 of the capsule model 75b from the distance D3. In this manner, the minimum radius R3min with respect to the capsule model 75b can be calculated in response to the position and orientation of the robot 1.

In the examples illustrated in FIG. 7 and FIG. 8, the specific member setting unit 51 sets the upper arm 11, the wrist 15, and the work tool 5 as specific members. Thus, the maximum external force estimation unit 54 can perform the same calculation as the calculation of the minimum radius of the capsule model 75b on the capsule model 75c and the capsule model 75d. Then, the minimum radius at which a distance from the drive axis J2 becomes minimum can be calculated for each surface of the capsule models 75b, 75c, and 75d. The maximum external force estimation unit 54 can select the smallest minimum radius among the minimum radii of the plurality of capsule models 75b, 75c, and 75d. In this example, the maximum external force estimation unit 54 can select a minimum radius R3min for the capsule model 75b of the upper arm 11. Then, the maximum external force estimation unit 54 can calculate a maximum external force by dividing the contact torque calculated by the contact torque calculating unit 53 by the minimum radius R3min.

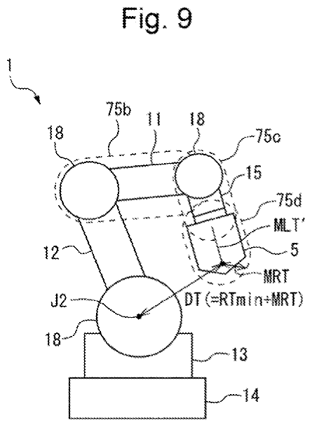

FIG. 9 is a schematic diagram of a third state when the first robot device of the present embodiment is driven. Also, in the example illustrated in FIG. 9, the specific member setting unit 51 sets the upper arm 11, the wrist 15, and the work tool 5 as specific members. A minimum radius is calculated for the capsule models 75b, 75c, and 75d corresponding to the respective constituent members.

In this case, a line segment MLT′ obtained by projecting a line segment MLT of the capsule model 75d of the work tool 5 onto the rotation plane is illustrated. At the position and orientation of the robot 1 illustrated in FIG. 9, the capsule model having the surface closest to the drive axis J2 is the capsule model 75d of the work tool. A value obtained by subtracting a distance MRT from a distance DT between an end point of the line segment MLT′ and the drive axis J2 is a minimum radius RTmin. The maximum external force estimation unit 54 can calculate a maximum external force by dividing a contact torque by the minimum radius RTmin.

In this manner, when the position and orientation of the robot are changed, the capsule model with the smallest distance from a predetermined drive axis is changed. When a plurality of constituent members are selected as specific members, the maximum external force estimation unit 54 can calculate a maximum external force by adopting the smallest minimum radius among minimum radii of respective capsule models.

In the example of the first robot device described above, the turning base 13 corresponds to a first constituent member. The lower arm 12 corresponds to a second constituent member. Then, the specific member setting unit 51 sets at least one constituent member selected from a group of the second constituent member and the constituent members arranged on the distal end side of the robot 1 with respect to the second constituent member as a specific member. In this case, the constituent members designated by the operator in FIG. 4 are set as specific members. The maximum external force estimation unit 54 can estimate a maximum external force based on the shortest distance between the drive axis and the specific members.

The determination unit 55 of the processing unit 50 determines whether or not the maximum external force deviates from a predetermined determination range. For example, the determination unit 55 determines whether or not the maximum external force is larger than a predetermined upper limit value. When the maximum external force is larger than the upper limit value, the operation change unit 56 can perform at least one control selected from a group of control for avoiding an increase in the external force and control for reducing the operation speed of the robot.

For example, the operation change unit 56 can perform control for stopping the robot 1. Alternatively, control for suppressing an increase in the external force can be performed by changing the travel direction of the tool center point of the robot 1. Alternatively, control for reducing a movement speed of the tool tip of the robot 1 can be performed. In this way, the operation change unit 56 can perform control for restricting the operation of the robot.

The same control as the control for a torque detected by the torque sensor 32 can be performed for torques detected by the torque sensors 31 and 33 which are arranged at the drive axes J1 and J3 other than the drive axis J2. In other words, the processing unit can create a capsule model of a specific member, calculate a minimum radius of the capsule model, and calculate a maximum external force based on the minimum radius. In controlling the robot based on outputs of the plurality of torque sensors 31, 32, and 33, when a maximum external force calculated from an output of at least one torque sensor deviates from a determination range, the processing unit can perform control for restricting the operation of the robot.

In this regard, the controller may be configured to select a drive axis to be adopted for evaluation of a state of the robot from among a plurality of drive axes included in the robot. The acquisition unit acquires a drive axis, which is selected by operation on an image displayed on the display part from among the plurality of drive axes included in the robot, as information for setting a specific member. The output unit can transmit the information of the selected drive axis to the processing unit. In the evaluation of a maximum external force described above, the controller may be configured to allow the operator to select a drive axis to be adopted when calculating a maximum external force. For example, it is possible to make a setting in which control using an output of the torque sensor arranged at the drive axis J2 is performed and control using outputs of the torque sensors arranged at the drive axes J1 and J3 is not performed. In this case, the display part can display a list of drive axes. The operator can select a drive axis to be adopted for controlling a maximum external force by operating the input part. The acquisition unit can acquire information on the drive axis to be adopted when a maximum external force is calculated. The output unit can transmit the information on the drive axis to be adopted when an external force is calculated to the processing unit.

The processing unit of the controller of the present embodiment sets at least one constituent member out of the plurality of constituent members of the robot as a specific member. The processing unit detects a state of operation of the specific member based on an output of the sensor and controls the operation of the robot based on the state of operation of the specific member. Thus, the robot can be controlled regardless of states of operation of the constituent members of the robot other than the specific member.

In the first robot device, an external force can be determined for a constituent member with which the operator may come into contact. On the other hand, constituent members with which the operator is unlikely to come into contact can be excluded from a specific member. In calculating a minimum radius for calculating a maximum external force, constituent members other than a specific member can be excluded. It is possible to avoid calculation of a maximum external force based on a constituent member with which the operator is unlikely to come into contact. Thus, it is possible to prevent a maximum external force from becoming excessively large and the operation of the robot from being restricted. As a result, reduction in the work efficiency of the robot can be suppressed.

In the present embodiment, the specific member setting unit sets a specific member based on operation by an operator on an image displayed on the display part. By employing this configuration, the operator can easily select a specific member from among the plurality of constituent members. The display part displays a list of the constituent members of the robot, and the specific member setting unit sets, as a specific member, a constituent member selected from the list of the constituent members in response to operation by the operator. Therefore, the operator can easily understand constituent members that can be selected. Also, the operator can be prevented from forgetting to set a specific member.

In the embodiment described above, a minimum radius for calculating a maximum external force is calculated using a capsule model, but the configuration is not limited thereto. A minimum radius can be calculated for each constituent member by any method. For example, only a line segment ML of a capsule model may be set for a constituent member, and the outer circumferential surface of the capsule model need not be set. A minimum radius may be calculated based on a distance from the line segment ML to a drive axis. In this method, since the thickness of the constituent member is not taken into consideration, an error occurs in a distance from the line segment to a surface of the constituent member. However, the calculation amount of the minimum radius can be reduced.

Alternatively, instead of a capsule model, a model covering a constituent member may be set with an aggregate of polyhedrons or cubes. Then, a distance from a surface of the model to a drive axis may be calculated. For example, by using a three-dimensional model of the robot, the shortest distance from a surface of the model having an arbitrary shape to a drive axis can be calculated.

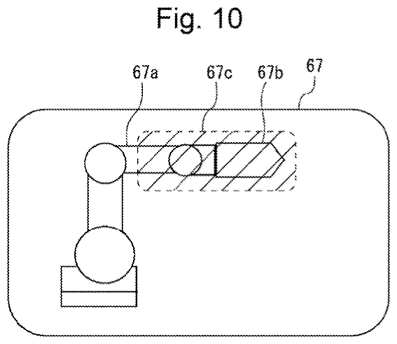

FIG. 10 illustrates a second image displayed on the display part according to the present embodiment. In a second control of the first robot device, a region in which an operator is likely to come into contact with the robot device is designated. In a second image 67, an image 67a of the robot and an image 67b of the work tool are displayed. The processing unit 50 is configured to designate a designated region 67c with respect to a constituent member of the robot 1 in response to operation by the operator on the image of the robot displayed on the display part 28. For example, when the display part 28 includes a display panel of a touch panel type, the operator can designate the designated region 67c covering a constituent member by tracing a screen with a finger. The operator can define the designated region 67c so as to include a constituent member with which the operator is likely to come into contact.

The acquisition unit 24 acquires the designated region 67c defined for an image of the robot 1 by operation on the image displayed on the display part 28. The output unit 25 transmits the image of the robot 1 and the designated region 67c to the specific member setting unit 51 as information for setting a specific member. The specific member setting unit 51 can set, as a specific member, a constituent member of the robot, at least a part of which is arranged inside the designated region 67c. In this example, a part of the upper arm, the wrist, and the work tool are arranged inside the designated region 67c. Thus, the specific member setting unit 51 sets the upper arm, the wrist, and the work tool as specific members.

It should be noted that the specific member setting unit may set a constituent member an entirety of which is included in the designated region as a specific member. For example, in the example illustrated in FIG. 10, since a part of the upper arm is arranged outside the designated region 67c, the upper arm need not be set as a specific member. In this manner, by the second control for selecting a specific member with a designated region, the operator can easily set a specific member from among the plurality of constituent members. In particular, when the number of constituent members of the robot is large, the operator can easily select a specific member.

In the embodiment described above, the operator selects a specific member by operating an image displayed on the display part, but the configuration is not limited thereto. A specific member may be stored in advance in the storage. Alternatively, there may be a configuration in which a specific member is selected in response to a state of operation of the robot.

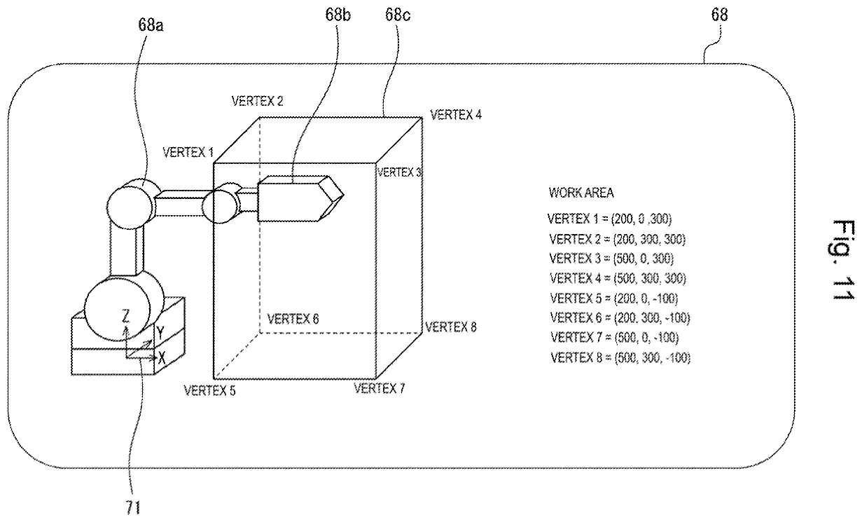

FIG. 11 illustrates a third image displayed on the display part according to the present embodiment. In a third control of the first robot device, a work area in which an operator performs work is designated in advance. In a third image 68, a three-dimensional image 68a of the robot and a three-dimensional image 68b of the work tool are displayed. Such three-dimensional images 68a and 68b can be created, for example, by acquiring three-dimensional data output from a computer-aided design (CAD) device.

The processing unit 50 is configured to be able to designate, around the robot 1, in response to operation by the operator, a work area 68c in which the operator performs work. The display part 28 displays the work area 68c together with the image 68a of the robot and the image 68b of the work tool. The work area 68c can be designated for an area within which the operator is likely to move. In this example, the work area 68c having a rectangular parallelepiped shape is defined by eight vertices. The position of each vertex is designated by coordinate values in the reference coordinate system 71. The work area 68c can be set by the operator operating the input part 27.

The work area is not limited to having a rectangular parallelepiped shape, but the work area may be set in any shape and any size. For example, a polygonal region formed by connecting a plurality of vertices can be set as the work area. Alternatively, one work area may be created by joining a plurality of regions.

The acquisition unit 24 acquires a position of a work area which is determined in advance with respect to a position of the robot. In this case, the acquisition unit 24 acquires the positions of the vertices of the work area as coordinate values in the reference coordinate system 71. The output unit 25 transmits the position of the work area to the specific member setting unit 51. The specific member setting unit 51 detects the position and orientation of the robot 1 based on an output of the position detector 23 during a period in which the robot is driven. The specific member setting unit 51 can set, as a specific member, a constituent member of the robot 1, at least a part of which is disposed inside the work area 68c.

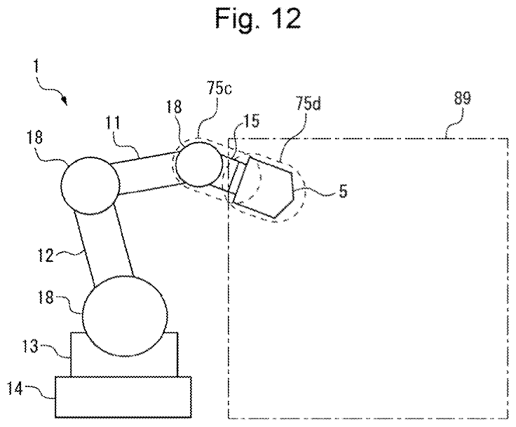

FIG. 12 illustrates a schematic diagram of the robot and a work area when the robot is actually driven. In this example, a part of the wrist 15 and the work tool 5 are arranged inside a work area 89. The specific member setting unit 51 sets the wrist 15 and the work tool 5 as specific members. The maximum external force estimation unit 54 sets the capsule model 75c for the wrist 15 and sets the capsule model 75d for the work tool 5. The maximum external force estimation unit 54 can calculate a minimum radius and calculate a maximum external force based on the minimum radius.

Alternatively, the specific member setting unit 51 sets capsule models for all the constituent members of the robot 1. Then, the specific member setting unit 51 may set a constituent member whose capsule model is at least partly arranged inside the work area 89 as a specific member.

In this manner, in the third control, a specific member can be set based on the position and orientation of the robot when the robot is in operation. By performing this control, the possibility of a constituent member arranged at a region other than the work area coming into contact with the operator can be eliminated. A constituent member that is likely to come into contact with the operator can be automatically changed in response to the position and orientation of the robot. As a result, restriction of the operation of the robot can be suppressed, and thus the work efficiency of the robot device is improved.

In the present embodiment, a constituent member having at least a part thereof arranged inside the work area during a period in which the robot is operating is set as a specific member, but the configuration is not limited thereto. A constituent member having an entirety thereof arranged inside the work area may be set as a specific member. In the example illustrated in FIG. 12, since a part of the wrist 15 is arranged outside the work area 89, the wrist 15 need not be set as a specific member.

In addition, the controller may be configured to allow an operator to set a work area and select a constituent member for calculating a maximum external force. For example, the acquisition unit selects a constituent member of the robot at least a part of which is arranged inside the work area when the robot is driven based on the operation program. In other words, the acquisition unit selects a constituent member of the robot based on a movable range of the robot according to the operation program and the work area. Alternatively, the acquisition unit may be configured to acquire a constituent member selected by operation on the input part by the operator. The acquisition unit acquires this constituent member of the robot as information for setting a specific member. Then, the specific member setting unit may set a specific member on which evaluation of an external force is to be performed based on the selected constituent member of the robot and the work area.

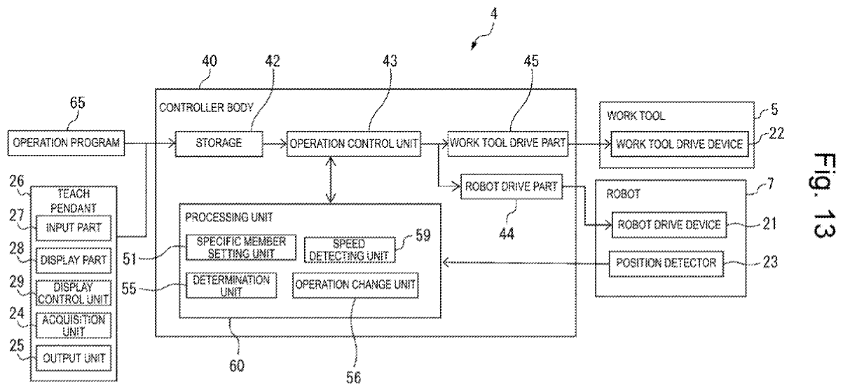

FIG. 13 illustrates a block diagram of a second robot device according to the present embodiment. In the second robot device, the operation of the robot is controlled based on a speed of a movement point set at a specific member. The second robot device includes a controller 4 that controls a robot 7 and the robot device. The robot 7 of the second robot device differs from the robot 1 of the first robot device 3 in that the torque sensors 31, 32, and 33 are not included.

The controller body 40 of the controller 4 includes a processing unit 60. Similar to the processing unit 50 of the first robot device 3, the processing unit 60 includes the specific member setting unit 51, the determination unit 55, and the operation change unit 56 (see FIG. 2). The processing unit 60 of the second robot device includes a speed detecting unit 59 that detects a speed at a movement point which is set in advance for a constituent member. The processing unit 60 and the speed detecting unit 59 correspond to a processor that is driven in accordance with the operation program 65. The processor functions as each unit by executing control defined in the operation program 65. The teach pendant 26 has a configuration similar to the configuration of the teach pendant 26 of the first robot device 3 (see FIG. 2).

The speed detecting unit 59 calculates a speed of a movement point at a specific member based on an output of the position detector 23. The position detector 23 detects a rotation angle as a variable for detecting a speed of a movement point at a constituent member.

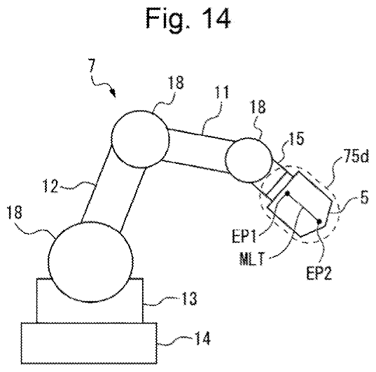

FIG. 14 illustrates a schematic diagram of the second robot device. Referring to FIG. 13 and FIG. 14, the specific member setting unit 51 sets at least one constituent member out of a plurality of constituent members of the robot 7 as a specific member. In this example, the work tool 5 is selected as a specific member. The speed detecting unit 59 sets a capsule model 75d represented by symbols (MLT, MRT) for the specific member. When the capsule model 75d is set, a line segment MLT having end points with respect to the work tool 5 is set. In the present embodiment, the end points of the line segment MLT are set as movement points EP1 and EP2. Speeds of the movement points EP1 and EP2 are adopted as a speed of the work tool 5.

In this regard, for a movement speed of the work tool 5, a safety speed Stol related to contact with an operator is predetermined. The safety speed Stol is a speed at which the safety of the operator is ensured when a person comes into contact with a constituent member of the robot. The safety speed Stol is set to an arbitrary speed by the operator. Alternatively, the safety speed Stol may be set in accordance with a standard or the like.

The speed detecting unit 59 detects speeds of the movement points EP1 and EP2 during a period in which the robot device is actually driven based on the operation program 65. The speed detecting unit 59 can detect the speeds of the movement points EP1 and EP2 based on an output of the position detector 23. The line segment MLT can be set in a coordinate system defined for each drive axis. The position of the origin and orientation of each coordinate system is calculated by a rotation angle of a drive motor arranged at each drive axis. The speed detecting unit 59 can calculate the speeds of the movement points EP1 and EP2 based on the positions of the movement points EP1 and EP2 and the operation time.

The determination unit 55 determines whether or not the speeds of the movement points EP1 and EP2 deviate from a predetermined determination range. When the speeds of the movement points EP1 and EP2 deviate from the determination range, the operation change unit 56 controls the robot 7 so as to decrease the speeds of the movement points EP1 and EP2. In the present embodiment, the determination unit 55 determines whether or not the speed of the movement point EP1 and the speed of the movement point EP2 exceed the safety speed Stol. When at least one speed selected from a group of the speed of the movement point EP1 and the speed of the movement point EP2 exceeds the safety speed Stol, the operation change unit 56 performs control for decreasing the operation speed of the robot 1 so as to decrease the speed of the movement point.

For example, there is a case where a reproduction speed of the operation program 65 can be adjusted in a range of 1% or more and 100% or less. When the speed of the movement point EP1 exceeds the safety speed, the operation speed of the robot 7 can be decreased by multiplying by a ratio at which the speed of the movement point EP1 falls within the safety speed. Similarly, for the movement point EP2, when the speed of the movement point EP2 exceeds the safety speed, the operation speed of the robot 7 can be decreased by multiplying by a ratio at which the speed of the movement point EP2 falls within the safety speed.

In this regard, when the operation speed of the robot exceeds the safety speed at a plurality of movement points, a ratio at which the operation speed of the robot becomes the lowest can be adopted. For example, it is assumed that while the safety speed is 100 mm/s, the speed of the movement point EP1 is 130 mm/s and the speed of the movement point EP2 is 150 mm/s when the reproduction speed is 100%. In this case, ratios for decreasing the speeds are 76% (calculated by 100%×100/130) and 66% (calculated by 100%×100/150), respectively. Among these ratios, 66% at which the ratio of the reproduction speed is small is adopted. In this case, the operation change unit 56 automatically reduces the reproduction speed of the operation program 65 to 66%. As a result, the speed of the movement point EP1 becomes 85.8 mm/see and the speed of the movement point EP2 becomes 99 mm/see, and both the movement points EP1 and EP2 are decelerated to the safety speed or less.

In the control of a comparative example, the operation speed of the robot can be limited by monitoring the speeds of all the constituent members of the robot. In other words, when at least a part of the constituent members deviates from a determination range of the safety speed, the operation of the robot can be restricted. However, since speeds of the constituent members with which the operator is unlikely to come into contact are monitored, opportunities of restricting the operation of the robot are increased, and the work efficiency of the robot device is reduced.

On the other hand, in the second robot device of the present embodiment, a constituent member with which the operator is likely to come into contact is set as a specific member in advance. Then, a speed of a movement point at a specific member can be determined. Therefore, the robot can be driven without limiting the speeds of constituent members having no possibility of contact. As a result, the opportunities of restricting the operation of the robot are reduced, and the work efficiency is improved.

For example, when the tool center point of the work tool is close to the drive axis J1, the joint at which the drive axis J3 is arranged may operate faster than the tool center point. In that case, by designating the work tool as a specific member, work of the robot device can be continued regardless of a speed of the joint at which the drive axis J3 is arranged.

In the embodiment described above, the end points of the line segment MLT of the capsule model 75d are set as the movement points EP1 and EP2, but the configuration is not limited thereto. An arbitrary point at a specific member can be set as a movement point. For example, in a coordinate system arranged at each drive axis, a movement point may be set in advance at a position on a surface of the constituent member farthest from the origin of the coordinate system. In addition, in the embodiment described above, an example has been explained in which the speed detecting unit 59 detects a speed of a movement point at a specific member based on an output of the position detector 23, but the configuration is not limited thereto. The speed detecting unit may detect a speed of a movement point based on an operation command transmitted by the operation control unit.

Other configurations, actions, and effects of the second robot device are similar to those of the first robot device, and the description thereof will not be repeated here.

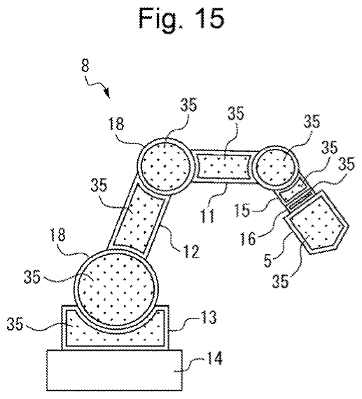

FIG. 15 illustrates a schematic diagram of a third robot device according to the present embodiment. The third robot device includes a robot 8. The robot 8 includes contact sensors 35 arranged so as to cover surfaces of respective constituent members. In addition, a contact sensor 35 is arranged so as to cover a surface of the work tool 5. The contact sensor 35 is a sensor that detects contact with a constituent member. The contact sensor 35 can be configured by, for example, a sheet-like pressure-sensitive sensor or a pressure sensor.

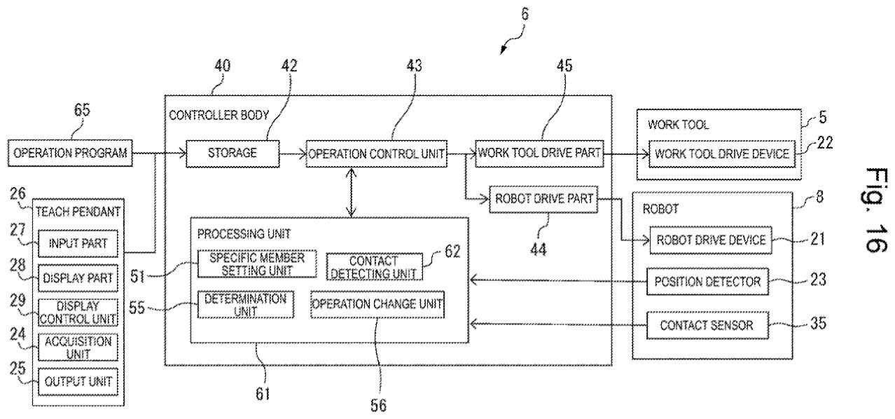

FIG. 16 illustrates a block diagram of the third robot device according to the present embodiment. The third robot device includes a controller 6 including a processing unit 61. The processing unit 61 has a configuration in which a contact detecting unit 62 is included instead of the speed detecting unit 59 of the processing unit 60 of the second robot device (see FIG. 13). The processing unit 61 and the contact detecting unit 62 correspond to a processor that is driven in accordance with the operation program 65. The processor functions as each unit by executing control defined in the operation program 65.

The specific member setting unit 51 sets at least one constituent member out of a plurality of constituent members of the robot 8 as a specific member. During a period in which the robot device is actually driven based on the operation program 65, the contact detecting unit 62 detects that a person is in contact with the robot 8 based on an output of the contact sensor 35 arranged at the specific member. The determination unit 55 determines whether or not a person is in contact with the specific member based on an output of the contact sensor 35. When it is determined that a person is in contact with the specific member of the robot 8, the operation change unit 56 can perform at least one control selected from a group of control for avoiding an increase in a contact force and control for reducing the operation speed of the robot. For example, the operation change unit 56 can perform control for stopping the robot 8.

Alternatively, the contact detecting unit 62 detects whether or not there is contact with a person for all the constituent members of the robot device. When the specific member set by the specific member setting unit 51 is included in the constituent members detected by the contact detecting unit 62, the determination unit 55 can determine that a person has come into contact with the specific member.

In the control of a comparative example, when contact with a person is detected by at least one contact sensor among the contact sensors arranged at the constituent members of the robot, the operation of the robot can be restricted. However, for example, when the robot includes a cable arranged outside a constituent member, the cable may come into contact with the contact sensor depending on the position and orientation of the robot. In that case, the operation of the robot is restricted and the work efficiency of the robot device is reduced.

On the other hand, in the third robot device of the present embodiment, the specific member setting unit sets in advance a constituent member with which the operator is likely to come into contact as a specific member. As a result, even when contact is detected at a constituent member with which the operator is unlikely to come into contact, the robot device can continue the operation, and the work efficiency is improved.

Other configurations, actions, and effects of the third robot device are similar to those of the first robot device and the second robot device, and the description thereof will not be repeated here.

In each of the above-described controls, the order of steps can be changed appropriately to the extent that the function and action are not changed.

The above embodiments can be combined as appropriate. In each of the above-described drawings, the same or equivalent parts are denoted by the same sign. The above embodiments are examples and do not limit the invention. In addition, the embodiments include the modifications of the embodiments defined in the claims.

### REFERENCE SIGNS LIST

1, 7, 8 Robot
2, 4, 6 Controller
3 Robot device
5 Work tool
11 Upper arm
12 Lower arm
13 Turning base
14 Base
15 Wrist
18 Joint
23 Position detector
24 Acquisition unit
25 Output unit
26 Teach pendant
27 Input part
28 Display part
31, 32, 33 Torque sensor
35 Contact sensor
50, 60, 61 Processing unit
51 Specific member setting unit
52 Torque detecting unit
53 Contact torque calculating unit
54 Maximum external force estimation unit
55 Determination unit
56 Operation change unit
59 Speed detecting unit
66, 66a, 66b Image
67, 67a, 67b Image
67c Designated region
68, 68a, 68b Image
68c Work area
89 Work area
EP1, EP2 Movement point
J1, J2, J3, J4, J5, J6 Drive axis

1. A controller configured to control a robot including a plurality of constituent members, the controller comprising:
a sensor configured to detect a state of operation of a constituent member; and
a processing unit configured to control operation of the robot based on an output of the sensor, wherein
the processing unit includes a specific member setting unit configured to set at least one constituent member out of the plurality of constituent members as a specific member, a determination unit configured to determine a state of operation of the specific member based on an output of the sensor, and an operation change unit configured to change operation of the robot based on a determination result of the determination unit.

2. The controller of claim 1, comprising a display part configured to display information regarding the constituent member of the robot, wherein the specific member setting unit is configured to set the specific member based on operation performed on an image displayed on the display part.

3. The controller of claim 2, wherein the display part is configured to display a list of the constituent members of the robot, and
the specific member setting unit is configured to set a constituent member selected from the list of the constituent members as the specific member.

4. The controller of claim 2, wherein the display part is configured to display an image of the robot, the processing unit is configured to designate, in response to the operation, a designated region with respect to the constituent member of the robot, and
the specific member setting unit is configured to set, as the specific member, a constituent member of the robot being at least partially arranged inside the designated region.

5. The controller of claim 2, wherein the processing unit is configured to designate, in response to the operation, a work area in which an operator performs work around the robot, and
the specific member setting unit is configured to acquire a position and an orientation of the robot during a period in which the robot is driven, and set, as the specific member, a constituent member of the robot being at least partially arranged inside the work area.

6. A robot device comprising:
the controller of claim 1; and
a robot including a plurality of constituent members.

7. The robot device of claim 6, wherein the processing unit includes a maximum external force estimation unit configured to estimate a maximum value of an external force acting on the robot when a person comes into contact with the robot,
the robot includes a first constituent member and a second constituent member, the second constituent member rotating about a drive axis with respect to the first constituent member,
the sensor includes a torque sensor configured to detect a torque around the drive axis,
the specific member setting unit is configured to set, as the specific member, at least one constituent member selected from a group of the second constituent member and the constituent member arranged on a distal end side of the robot with respect to the second constituent member,
the maximum external force estimation unit is configured to estimate a maximum external force based on a distance between the drive axis and the specific member,
the determination unit is configured to determine whether or not the maximum external force deviates from a determination range defined in advance, and
the operation change unit is configured to perform at least one control selected from a group of control for avoiding an increase in the external force and control for reducing an operation speed of the robot when the maximum external force deviates from the determination range.

8. The robot device of claim 6, wherein the processing unit includes a speed detecting unit configured to detect a speed at a movement point defined in advance for the constituent member,
the sensor is configured to detect a variable for calculating a speed of the movement point,
the speed detecting unit is configured to detect the speed of the movement point at the specific member based on an output of the sensor,
the determination unit is configured to determine whether or not the speed of the movement point deviates from a determination range defined in advance, and
the operation change unit is configured to control the robot so as to reduce the speed of the movement point when the speed of the movement point deviates from the determination range.

9. The robot device of claim 6, wherein the sensor includes a contact sensor configured to detect contact with the robot,
the determination unit is configured to determine whether or not a person is in contact with the specific member based on an output of the contact sensor, and
the operation change unit is configured to perform at least one control selected from a group of control for avoiding an increase in a contact force and control for reducing an operation speed of the robot when a person is determined to be in contact with the specific member.

10. An operating device for setting a parameter for controlling a robot, the operating device comprising:
a display part configured to display an image of the robot;
an acquisition unit configured to acquire information for setting, from among constituent members of the robot, a specific member having a possibility of contact based on operation on an image displayed on the display part; and
an output unit configured to output the information for setting a specific member.

11. The operating device of claim 10, wherein the display part is configured to display a work area in which an operator performs work around the robot, and
the acquisition unit is configured to acquire a position of the work area defined with respect to a position of the robot in response to the operation.

12. The operating device of claim 11, wherein the acquisition unit is configured to acquire a constituent member of the robot, the constituent member being at least partially arranged inside the work area when the robot is driven based on an operation program.

13. The operating device of claim 10, wherein the acquisition unit is configured to acquire a constituent member of the robot, the constituent member being selected by operation on an image displayed on the display part.

14. The operating device of claim 10, wherein the acquisition unit is configured to acquire a designated region defined for selecting a specific member with respect to the image of the robot by operation on an image displayed on the display part.

15. The operating device of claim 10, wherein the acquisition unit is configured to acquire a drive axis selected from among a plurality of drive axes of the robot by operation on an image displayed on the display part.
